(19) United States
(12) Patent Application Publication
(10) Pub. No.: US 2002/0085747 A1
(43) Pub. Date: Jul. 4, 2002

(54) IMAGE PROCESSING APPARATUS AND METHOD, IMAGE CAPTURING APPARATUS, AND INFORMATION PROVISION MEDIUM

(76) Inventors: TAKAYUKI YOSHIGAHARA, TOKYO (JP); YOKO MIWA, TOKYO (JP); ATSUSHI YOKOYAMA, KANAGAWA (JP)

Correspondence Address: BELL, BOYD & LLOYD, LLC, P. O. BOX 1135, CHICAGO, IL, 60690-1135, US

(21) Appl. No.: 09/174,382

(22) Filed: Oct. 16, 1998

(30) Foreign Application Priority Data
Oct. 21, 1997 (JP) P09-288480

(51) Int. Cl. G06K 9/00

(52) U.S. Cl. 382/154

(57) ABSTRACT

An image processing apparatus performs predetermined processing for images captured by a plurality of image capturing apparatuses. In the image processing apparatus, the images captured by the image capturing apparatuses are as a base image and at least one reference image. Evaluation values representing correspondence in pixels in each reference image to the pixels of the base image are computed. The images captured by the image capturing apparatuses are assigned to groups so that each group includes the base image and at least one reference image. From groups obtained by the grouping, a group having highest base-image to reference-image correspondence is selected. A distance to a point on an object by determining parallax is computed based on the evaluation values for the selected group.

### BACKGROUND OF THE INVENTION

1. Field of the Invention

The present invention relates to image processing apparatuses and methods, and in particular, to an image processing apparatus and method, an image capturing apparatus, and an information provision medium in which a pair of stereographic images is used to perform three-dimensional distance determination.

2. Description of the Related Art

Stereographic processing using a plurality of cameras is known as a method for measuring a distance to a subject. In such stereographic processing, among images of the same subject captured at a plurality of viewpoints (cameras), corresponding pixels are specified, and the distance between the corresponding pixels is used to determine the distance from the cameras to the subject based on the principles of triangulation.

In order that the corresponding pixels in two stereographic images (i.e., a pair of stereographic images) may be specified, area-base matching must be performed.

General stereographic processing will be described below with reference to FIGS. 1A to 1C.

Stereographic Image Processing

FIGS. 1A to 1C show general stereographic processing.

Stereographic processing correlates pixels with one another among a plurality of images of the same object captured from two or more directions by cameras, and transforms parallax information between corresponding pixels into distance information from the cameras to the object; the distance to the object, its shape, or both may thereby be determined.

By using two cameras A 110₁ and B 110₂ to capture the image of an object 122 as shown in FIG. 1A, an image (base image) 124a from camera A 110₁ including the image 220a of the object 122, and an image (reference image) 124b from camera B 110₂ including the image 220b of the object 122 are obtained as shown in FIG. 1B. The images 220a and 220b of the object 122 include pixels (corresponding points k and k′) of an identical portion of the object 122.

By detecting corresponding points between the base image 124a and the reference image 124b, the parallax between the corresponding points k and k′ can be found in units of pixels.

Based on the obtained parallax between the corresponding points k and k′, the angles (camera angles) of the two cameras A 110₁ and B 110₂, and the distance between the cameras, the principles of triangulation may be applied to determine the distance between each point on the object 122 and camera A 110₁ or camera B 110₂, and the shape of the object 122 can be analyzed based on the distance to each point on the object 122.

Area-base Matching

In the stereographic processing, a method employed that correlates point (pixel) k in the object image 220a in the base image 124a with the corresponding point (pixel) k′ in the object image 220b in the reference image 124b is, for example, area-base matching.

In area-base matching, an epipolar line is first computed. As shown in FIG. 1B, the epipolar line is, for example, a virtual straight broken line drawn in the reference image 124b based on the distance between the cameras A 110₁ and B 110₂, their angles (positional relationship), and the position of a pixel in the object image 220a in the reference image 124a, and represents a range where point k′ corresponding to pixel k exists in the reference image 124b. Next, the correlation between a square pixel block in the reference image 124b including n×n pixels (where, e.g., n=5), with each pixel on the epipolar line used as a central pixel, and a square pixel block in the base image 124a including n×n pixels, with pixel k used as a central pixel, is evaluated using a predetermined evaluation function, and the central pixel in the pixel block having the highest correlation in the reference image 124b is detected as point k′ corresponding to pixel k.

The reason the n×n pixel block is used to detect the corresponding point is that the effects of noise are reduced, and the correlation between a feature of a pixel pattern around pixel k and a feature of a pixel pattern around corresponding point k′ in the reference image 124b is clarified and evaluated, and corresponding point detection can thereby be performed reliably. In particular, the larger the pixel block used for the base image 124a and the reference image 124b, which differ slightly, the greater the certainty of corresponding point detection.

In other words, this stereographic processing uses area-base matching to perform the steps of sequentially finding the correlations between pixel blocks in the base image 124a and the reference image 124b, while changing parallax along the epipolar line in the reference image 124b corresponding to pixel k in the reference image 124a; detecting a pixel in the reference image 124b having the highest correlation as point k′ corresponding to pixel k; and computing the parallax between the detected corresponding points k and k′.

The distance from camera A 110₁ or camera B 110₂ to each point on the object 122 can be computed based on the obtained parallax, and the positional relationship of cameras A 110₁ and B 110₂.

When the above-described processing is performed to compute the distance, if errors occur in specifying corresponding points (i.e., false correlations are generated), accurate distance cannot be computed. In particular, false correlations easily occurs when performing area-base matching for stereographic images having as a subject similar objects arranged in parallel (i.e., elements in a repeating pattern). A method for solving this problem is known in which a base camera 3 and reference cameras 4-1 and 4-2 that are aligned capture the image of a subject. An image captured by the base camera 3 is referred to as “J0” (base image), and images captured by the reference cameras 4-1 and 4-2 are referred to as “J1 and J2” (reference images), respectively. A base line for the base camera 3 and the reference camera 4-1 is referred to as “L₁”, and a base line for the base camera 1 and the reference camera 4-2 is referred to as “L₂”. The base line is the interval (distance) between a pair of cameras.

Next, a method for computing the distance from cameras to a subject will be described with reference to FIG. 3. For measuring distance Z from a base camera 3 to object point P, the base camera 3 and a reference camera 4 are positioned with predetermined distance L provided therebetween so that the optical axis of the base camera 3 and the optical axis are parallel. In the reference camera 4, distance (parallax) d between point P₀ at which the optical axes on a screen cross, and point P_{P} at which the image object point P is formed, is determined using the above-described area-base matching. Distance Z is computed based on Z=LF/d where F represents the distance between a viewpoint in the reference camera 4 and the screen.

FIGS. 4A to 4D show correlation functions of pairs of stereographic images. The horizontal axis represents parallax d. The vertical axis represents values of correlation. The greater the values, the higher the correlation (the higher the probability of being a corresponding pixel). It is known that precision of area-base matching is increased by adding correlation functions of pairs of stereographic images.

FIG. 4A shows a correlation function of a pair of stereographic images composed of base image J0 and reference image J1. Base image J0 and reference image J1 are obtained by capturing the image of a repetitive-pattern subject. Accordingly, a maximum correlation value appears repetitively in FIG. 4A. d₁ represents a first high value of parallax.

FIG. 4B shows a correlation function of a pair of stereographic images composed of base image J0 and reference image J2. In addition, base image J0 and reference image J2 are obtained by capturing the image of a repetitive-pattern subject. Accordingly, a maximum correlation value appears repetitively in FIG. 4B. d₂ represents a first high value of parallax.

In the functions shown in FIGS. 4A and 4B, as well as in the sum of these functions, a maximum value of correlation appears repetitively.

Here, as shown in FIG. 4C, in order to set d₁ in FIG. 4A and d₂ in FIG. 4B at the same position, the horizontal axis (parallax) in FIG. 4B is multiplied by d₁/d₂. Since base line L and parallax d have a relationship of L₁:L₂=d₁:d₂, parallax d may be multiplied by L₁/L₂.

A function obtained by adding the functions shown in FIGS. 4A and 4B as described above is shown in FIG. 4D. As shown in FIG. 4D, a maximum value of correlation appears at only parallax d₁. Thus, correct parallax d can be found. In other words, by performing area-base matching with two or more pairs of stereographic images having different base lines B, correct parallax can be found for a repetitive-pattern subject.

Concerning the arrangement of cameras, in addition to the one described above, reference cameras 4-1 to 4-4 may be arranged at regular intervals in four directions from base camera 3 as shown in FIG. 5.

The camera-aligned arrangement shown in FIG. 2 is useful in area-base matching for a subject having a repeating pattern parallel to the camera row. However, it causes a maximum value of correlation to appear repetitively in the correlation function for subjects having vertical and horizontal repeating patterns as shown in FIGS. 6A and 6B. As a result, false correlations may be disadvantageously generated, which would preclude finding the correct parallax.

The camera arrangement shown in FIG. 5 may also cause a problem in that correct parallax for a subject having a repeating pattern cannot be found because the distances from the base camera 3 to the reference cameras 4-1 to 4-4 are equal (one base line).

### SUMMARY OF THE INVENTION

Accordingly, the present invention has been made in view of the foregoing circumstances, and an object thereof is to provide an image processing apparatus and method, an image capturing apparatus, and an information provision medium in which pairs of stereographic images captured on two or more base lines are used, whereby error in measurement for a subject having a repeating pattern is reduced.

To this end, according to an aspect of the present invention, the foregoing object has been achieved through the provision of an image processing apparatus for performing predetermined processing for images captured by a plurality of image capturing apparatuses, comprising: input means for inputting as a base image and at least one reference image the images captured by the image capturing apparatuses; evaluation means for computing evaluation values representing correspondences in pixels in each reference image to the pixels of the base image; selecting means for assigning the images captured by the plurality of image capturing apparatuses to groups so that each group includes the base image and at least one reference image, and selecting from among the groups a group having highest base-image to reference-image correspondence; and distance computation means for computing based on the evaluation values for the group selected by the selecting means a distance to a point on an object by determining parallax.

According to another aspect of the present invention, the foregoing object has been achieved through the provision of an image processing method for performing predetermined processing for images captured by a plurality of image capturing apparatuses, comprising the steps of: inputting as a base image and at least one reference image the images captured by the plurality of image capturing apparatuses; computing evaluation values representing correspondences in pixels in each reference image to the pixels of the base image; assigning the images captured by the plurality of image capturing apparatuses to groups so that each group includes the base image and at least one reference image; selecting from among the groups a group having highest base-image to reference-image correspondence; and computing based on the evaluation values for the selected group a distance to a point on an object by determining parallax.

According to a further aspect of the present invention, the foregoing object has been achieved through the provision of an information provision medium for providing control commands for performing predetermined image processing to images captured by a plurality of image capturing apparatuses, the control commands comprising the steps of: inputting as a base image and at least one reference image the images captured by the plurality of image capturing apparatuses; computing evaluation values representing correspondences in pixels in each reference image to the pixels of the base image; assigning the images captured by the plurality of image capturing apparatuses to groups so that each group includes the base image and at least one reference image; selecting from among the groups a group having highest base-image to reference-image correspondence; and computing based on the evaluation values for the selected group a distance to a point on an object by determining parallax.

According to a still further aspect of the present invention, the foregoing object has been achieved through the provision of an image processing apparatus for performing predetermined processing for images captured by a plurality of image capturing apparatuses, comprising: input means for inputting the images captured by the plurality of apparatuses; and distance computing means for determining parallax based on the images input by the input means, and computing a distance to a point on an object, wherein around a first image-capturing apparatus among the plurality of image capturing apparatuses, the image capturing apparatuses excluding the first image-capturing apparatus are positioned, and among the plurality of image capturing apparatuses, second and third image-capturing apparatuses used as processing units in the parallax determination are positioned in different directions with respect to the first image-capturing apparatus so as to have different distances with respect to the first image-capturing apparatus.

According to an even further aspect of the present invention, the foregoing object has been achieved through the provision of an image-capturing system composed of a plurality of image capturing apparatuses including a base image-capturing apparatus and a plurality of reference image-capturing apparatuses positioned around the base image-capturing apparatus, wherein among the reference image-capturing apparatuses, first and second reference image-capturing apparatuses are positioned at different angles with respect to the base image-capturing apparatus, and are positioned having different distances with respect to the base image-capturing apparatus.

According to the present invention, error in measurement for a subject having a horizontal and vertical repeating pattern can be reduced.

### BRIEF DESCRIPTION OF THE DRAWINGS

FIGS. 1A to 1C are views showing stereographic image processing.

FIG. 2 is a view showing a conventional arrangement of a base camera 3 and reference cameras 4-1 and 4-2.

FIG. 3 is a drawing illustrating a method for computing distance Z between a base camera 3 and object point P.

FIGS. 4A to 4d are graphs showing pixel correlation.

FIG. 5 is a view showing another conventional arrangement of a base camera 3 and reference cameras 4-1 and 4-2.

FIGS. 6A and 6B are drawings showing subjects having repeating patterns.

FIG. 7 is a block diagram showing an image processing system to which the present invention is applied.

FIG. 8 is a flowchart illustrating the operation of the image processing system shown in FIG. 7.

FIG. 9 is a view showing an arrangement of a base camera 3 and reference cameras 4-1 to 4-4.

FIGS. 10A to 10D are views showing the grouping of a base camera 3 and reference cameras 4-1 to 4-4.

FIG. 11 is a view showing another arrangement of a base camera 3 and reference cameras 4-1 to 4-4.

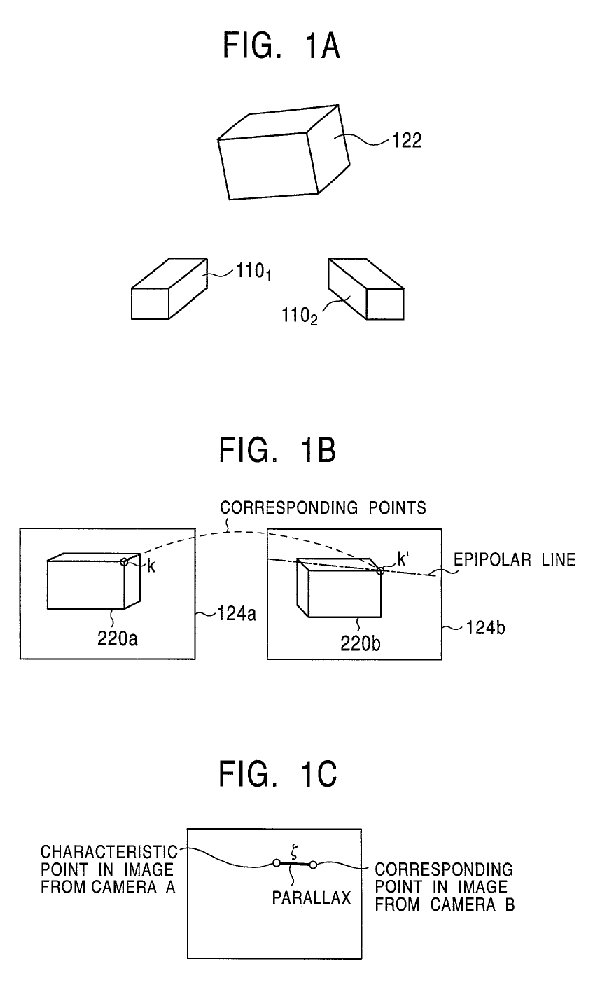

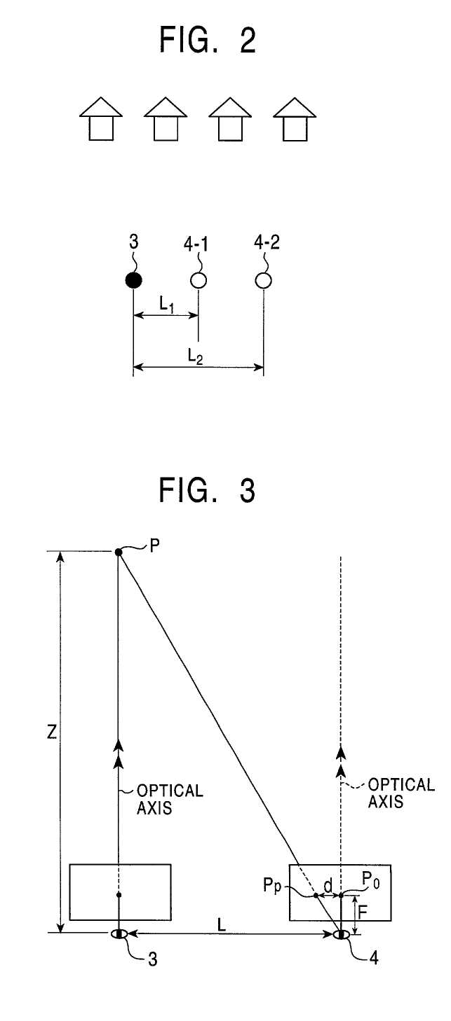

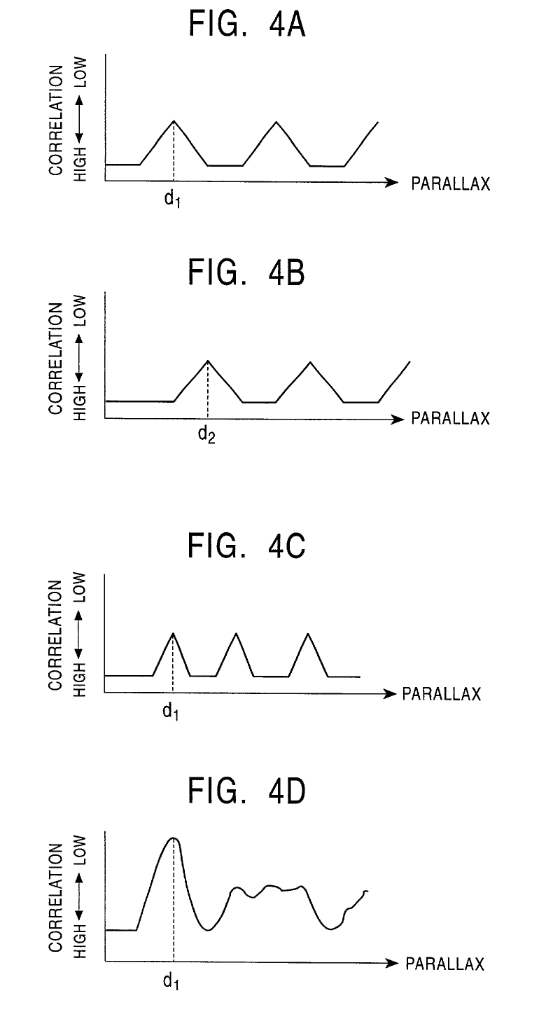

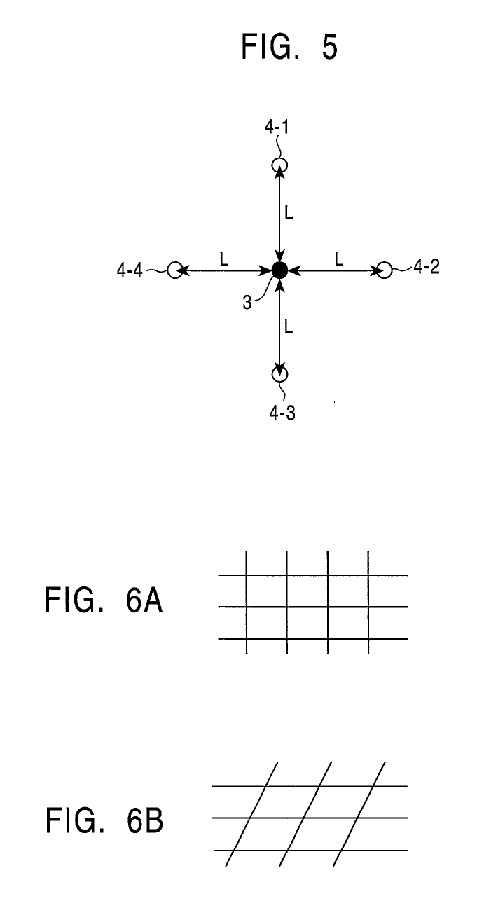

### DESCRIPTION OF THE PREFERRED EMBODIMENT

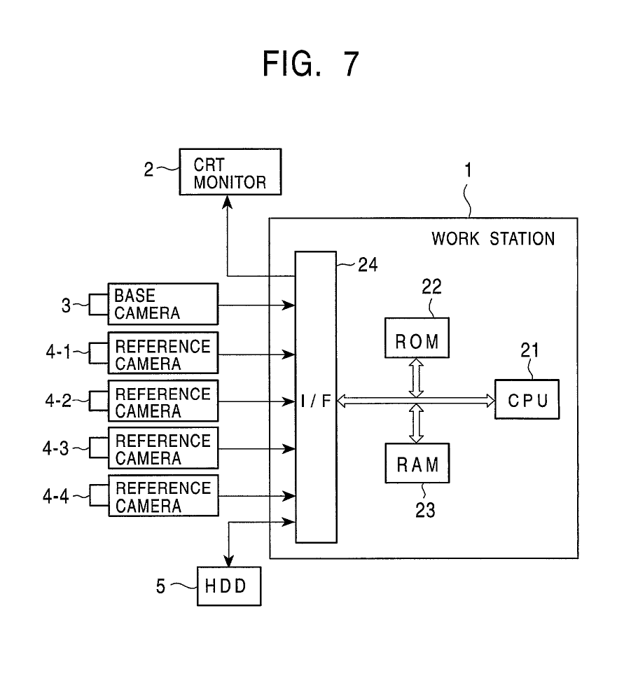

An image processing system to which the present invention is applied will be described with reference to FIG. 7. The image processing system includes an image processing circuit (workstation) 1, a cathode-ray-tube (CRT) monitor 2, a base camera 3, reference cameras 4-1 to 4-4 (hereinafter referred to as “cameras 4” in the case where the reference cameras 4-1 to 4-4 do not need to be distinguished), and a hard disk drive (HDD) 5. In this specification, the word “system” means a combination of apparatuses and means.

The image processing circuit 1 includes a central processing unit (CPU) 21, a read-only memory (ROM) 22, a random access memory (RAM) 23, and an interface (I/F) 24. The image processing circuit 1 performs predetermined processing for an image signal input from the base camera 3 and the reference cameras 4.

The CPU 21 controls the units of the image processing circuit 1, and can carry out predetermined operations in accordance with programs. Programs to be executed are stored in the ROM 22 and the RAM 23. The interface 24 performs appropriate data format transformation in the case where data are sent and received between the image processing circuit 1 and external units (the base camera 3, etc.).

The CRT monitor 2 displays an image output from the image processing circuit 1. The base camera 3 and the reference cameras 4 can convert the optical image of a subject into the corresponding electric signal (image signal) before outputting it.

The image signal output from the base camera 3 and the reference cameras 4 and various programs are recorded to or reproduced from the HDD 5. In the HDD 5, a program for performing the following processing is stored.

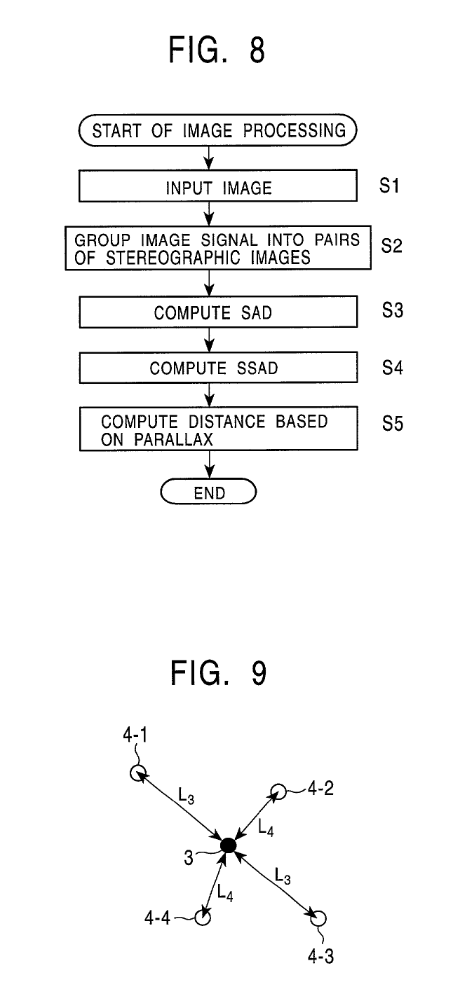

Next, a process performed by the image processing system will be described with reference to the flowchart shown in FIG. 8. An image signal output by the base camera 3 is referred to as “G0”, and image signals output by the reference cameras 4-1, 4-2, 4-3, and 4-4, are referred to as “G1, G2, G3, and G4”, respectively.

In step S1, the base camera 3 and the reference cameras 4-1 to 4-4 convert optical signals based on a subject into image signals, and output them to the image processing circuit 1. The image processing circuit 1 outputs the input image signals G0 to G4 to the HDD 5. The HDD 5 holds the input image signals G0 to G4.

In step S2, the image processing circuit 1 groups image signals G0 to G4 into two pairs of stereographic images.

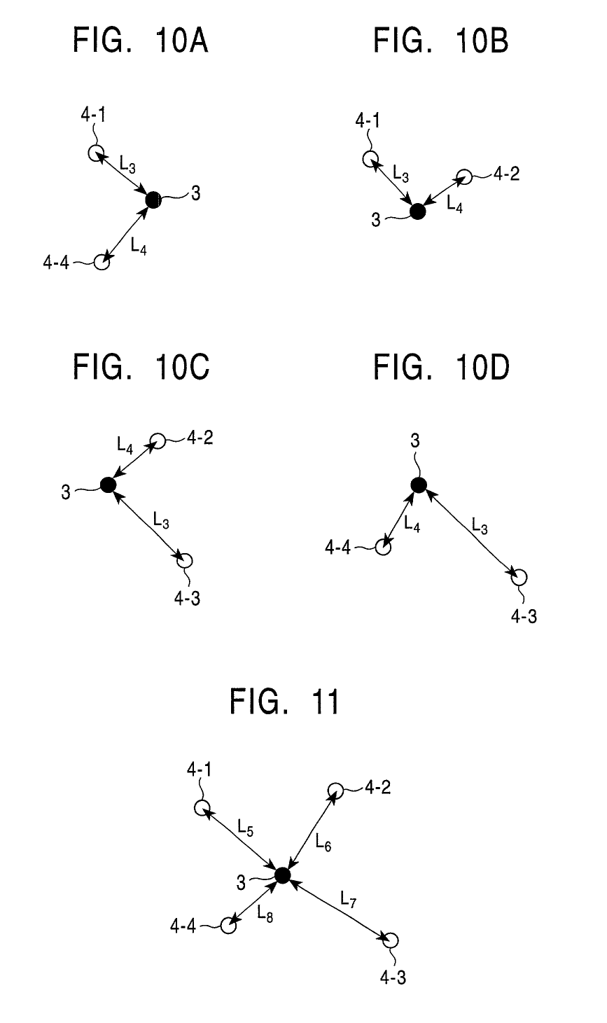

The details of the grouping into pairs of stereographic images in step S2 will be described with reference to FIGS. 9, and 10A to 10D. FIG. 9 shows an arrangement of five cameras: the base camera 3, and the reference cameras 4-1 to 4-4. The base camera 3 is positioned in the center. The reference camera 4-1 is positioned having distance L3 in the upper left direction from the base camera 3. The reference camera 4-2 is positioned having distance L4 in the upper right direction from the base camera 3. The reference camera 4-3 is positioned having distance L3 in the lower right direction from the base camera 3. The reference camera 4-4 is positioned having distance L4 in the lower left direction from the base camera 3.

Using the five cameras, sets each composed of three cameras are formed. For eliminating effects of occlusion (meaning that an object point that is viewed by one camera of a set cannot be viewed by the other cameras)(See Transactions of the Institute of Electronics, Information and Communication Engineers, D-2, Vol. J80-D-2, No. 6, pp. 1432-1440, June 1997), one base camera 3 must be included in three cameras constituting one set. Four sets of three cameras are shown in FIGS. 10A to 10D.

For example, the set shown in FIG. 10A consists of a base camera 3, reference cameras 4-1 and 4-4. In the set shown in FIG. 10A, image signal G0 output by the reference camera 3 and image signal G1 output by the reference camera 4-1 are combined to form a first pair of stereographic images, and image signal G0 output by the base camera 3 and image signal G4 output by the reference camera 4-4 are combined to form a second pair of stereographic images.

In step S3, evaluation value SAD representing correlation between the pairs of stereographic images is computed using the following equation:

$$SAD ( x , y ζ , ξ ) = {\sum }_{i , j ∈ w} \vert f ( x + i , y + j ) - g ( x + i + {R}_{k} ζ , y + j + {R}_{k} ξ ) \vert$$

where W represents an area-base matching region, x and y represent the x and y coordinates of object point P on image signal G0 captured by the base camera 3, f(X,Y) represents the brightness level of GO output from the base camera 3, g(X,Y) represents the brightness level of an image signal other than image signal G0 in the stereographic-image pair, ζ and ξ represent parallax in the x and y directions, Lₙ represents the longest base line in all pairs of stereographic images, Lₖ represents the base line of the pair of stereographic images which is being referred to, and Rₖ represents a base-line ratio of Rₖ=Lₖ/Lₙ.

For example, in the set shown in FIG. 10A, based on two pairs of stereographic images having different base lines (one stereographic-image pair composed of image signals G0 and G1, and one stereographic-image pair composed of image signals G0 and G4), two SADs are computed. This also applies to the sets shown in FIGS. 10B to 10D.

In step S4, the image processing circuit 1 computes SSAD, namely, the sum of SADs corresponding to the pairs of stereographic images computed in step S3, using the following equation:

$$SSAD ( x , y ζ , ξ ) = {{\sum }_{k = 1}}^{n} ( {\sum }_{i , j ∈ w} \vert f ( x + i , y + j ) - g ( x + i + {R}_{k} ζ , y + 1 + {R}_{k} ξ ) \vert )$$

It is known that the higher the correlation, the smaller the value of SSAD. (See Transactions of the Institute of Electronics, Information and Communication Engineers, D-2, Vol. J75-D-2, No. 8, pp. 1317-1327, August 1992)

In the case of the set shown in FIG. 10A, by adding two SADs computed based on the pair of stereographic images composed of image signals G0 and G1, and the pair of stereographic images composed of G0 and G4, an SSAD is obtained. This also applies to the sets shown in FIGS. 10B to 10D.

In step S5, four SSADs computed from the respective sets are compared, and the distance between the base camera 3 and object point P is computed using as correct parallax the parallax ζ and ξ corresponding to the least SSAD.

Next, an arrangement of the five cameras will be described with reference to FIG. 11. As shown in FIG. 11, reference cameras 4-1 to 4-4 are positioned having different distances from a base camera 3. The base camera 3 is positioned in the center. The reference camera 4-1 is positioned having distance L₅ in the upper left direction from the base camera 3. The reference camera 4-2 is positioned having distance L₆ in the upper right direction from the base camera 3. The reference camera 4-3 is positioned having distance L₇ in the lower left direction from the base camera 3. The reference camera 4-4 is positioned having distance L₈ in the lower left direction from the base camera 3.

In this arrangement, by combining image signal G0 output from the base camera 3, and image signals G1 to G4 output from the reference cameras 4-1 to 4-4, four pairs of stereographic images are formed, and four SADs are computed. the sum of the four SADs is found as an SSAD, and the distance between the base camera 3 and object point P is computed using as correct parallax the parallax ζ and ξ corresponding to the least SSAD.

Although the above-described embodiment uses one base camera and four reference cameras, three, or five or more reference cameras may be used.

Although the above-described embodiment finds an evaluation values based on SAD values, the sum of other values representing correlation may be used as evaluation values. By way of example, by using the following sum-of-squared difference (SSD) function:

$$SSD ( x , y , η , ξ ) = {\sum }_{i , j ∈ w} {\{ I ( x + i , y + j ) - J ( x + i + {R}_{k} η , y + j + {R}_{k} ξ ) \}}^{2}$$

the following sum-of-SSDs (SSSD):

$$SSSD ( x , y , η , ξ ) = {{\sum }_{k = 1}}^{n} ( {\sum }_{i , j ∈ w} {\{ I ( x + i , y + j ) - J ( x + i + {R}_{k} η , y + j + {R}_{k} ξ ) \}}^{2} )$$

is used as an evaluation value.

In the above-described embodiment, a program for executing image processing according to the present invention is supplied from the HDD 5. However, the program may be supplied using the interface 24 connecting to another information processing apparatus via a transmission medium such as a network.

What is claimed is:

1. An image processing apparatus for performing predetermined processing for images captured by a plurality of image capturing apparatuses, comprising:
input means for inputting as a base image and at least one reference image said images captured by said image capturing apparatuses;
evaluation means for computing evaluation values representing correspondences in pixels in each reference image to the pixels of the base image;
selecting means for assigning said images captured by said plurality of image capturing apparatuses to groups so that each group includes the base image and at least one reference image, and selecting from among said groups a group having highest base-image to reference-image correspondence; and
distance computation means for computing based on said evaluation values for the group selected by said selecting means a distance to a point on an object by determining parallax.

2. An image processing apparatus according to claim 1, wherein said evaluation means computes evaluation values representing correlations.

3. An image processing apparatus according to claim 1, wherein grouping is performed using a base image and a reference image as a pair, and using adjacent pairs as a set.

4. An image processing method for performing predetermined processing for images captured by a plurality of image capturing apparatuses, comprising the steps of:
inputting as a base image and at least one reference image said images captured by said plurality of image capturing apparatuses;
computing evaluation values representing correspondences in pixels in each reference image to the pixels of the base image;
assigning said images captured by said plurality of image capturing apparatuses to groups so that each group includes the base image and at least one reference image;
selecting from among said groups a group having highest base-image to reference-image correspondence; and
computing based on the evaluation values for the selected group a distance to a point on an object by determining parallax.

5. An image processing method according to claim 4, wherein the computed evaluation values represent correlations.

6. An image processing method according to claim 4, wherein grouping is performed using a base image and a reference image as a pair, and using adjacent pairs as a set.

7. An information provision medium for providing control commands for performing predetermined image processing to images captured by a plurality of image capturing apparatuses, said control commands comprising the steps of: inputting as a base image and at least one reference image said images captured by said plurality of image capturing apparatuses; computing evaluation values representing correspondences in pixels in each reference image to the pixels of the base image; assigning said images captured by said plurality of image capturing apparatuses to groups so that each group includes the base image and at least one reference image; selecting from among said groups a group having highest base-image to reference-image correspondence; and computing based on the evaluation values for the selected group a distance to a point on an object by determining parallax.

8. An image processing apparatus for performing predetermined processing for images captured by a plurality of image capturing apparatuses, comprising:
input means for inputting said images captured by said plurality of apparatuses; and
distance computing means for determining parallax based on the images input by said input means, and computing a distance to a point on an object,
wherein around a first image-capturing apparatus among said plurality of image capturing apparatuses, the image capturing apparatuses excluding said first image-capturing apparatus are positioned, and
among said plurality of image capturing apparatuses, second and third image-capturing apparatuses used as processing units in the parallax determination are positioned in different directions with respect to said first image-capturing apparatus so as to have different distances with respect to said first image-capturing apparatus.

9. An image processing apparatus according to claim 8, wherein all the distances between said first image-capturing apparatus and the image capturing apparatuses excluding said first image-capturing apparatus differ.

10. An image processing apparatus according to claim 8, wherein the image capturing apparatuses excluding said first image-capturing apparatus are two-dimensionally positioned around said first image-capturing apparatus.

11. An image processing apparatus according to claim 8, wherein the number of said plurality of image capturing apparatuses is five.

12. An image processing apparatus according to claim 8, wherein said plurality of image capturing apparatuses include a plurality of second and third image-capturing apparatuses.

13. An image-capturing system composed of a plurality of image capturing apparatuses including a base image-capturing apparatus and a plurality of reference image-capturing apparatuses positioned around said base image-capturing apparatus, wherein among said reference image-capturing apparatuses, first and second reference image-capturing apparatuses are positioned at different angles with respect to said base image-capturing apparatus, and are positioned having different distances with respect to said base image-capturing apparatus.

14. An image-capturing system according to claim 13, wherein said first and second reference image-capturing apparatuses are adjacently positioned.
